(19) United States
(12) Patent Application Publication
(10) Pub. No.: US 2007/0125868 A1
(43) Pub. Date: Jun. 7, 2007

(54) Disposable serial package and monitoring system thereof

(76) Inventors: Min-Kao Hong, Hsinchu Hsien (TW); Chie-Chung Kuo, Hsinchu (TW); Yu-Chin Hsu, Hsinchu (TW); Vivian Wang, Hsinchu (TW)

Correspondence Address: RABIN & BERDO, P.C., Suite 500, 1101 14th Street, N.W., Washington, DC, 20005, US

(21) Appl. No.: 11/437,663

(22) Filed: May 22, 2006

(30) Foreign Application Priority Data
Dec. 1, 2005 (TW) 094142236

(51) Int. Cl. G06K 19/06

(52) U.S. Cl. 235/492

(57) ABSTRACT

A disposable serial package and its monitoring system are proposed. Conductive structures are provided on each of several package units detachably attached in series forming the disposable serial package. Each conductive structure has several leads and each of the leads has a front end and a tail end. The tail end of a second lead being connected to a first lead on the same conductive structure and a third lead of any one of the package units is connected to the front end of the second lead of a succeeding package unit. A monitoring device is cooperatively used to allow setting of the quantity of package units to be monitored and the instantaneous quantity of package units based on the conducting state of the leads.

### FIELD OF THE INVENTION

The present invention relates to a technique for monitoring packages, and more particularly, to a disposable serial package and monitoring system thereof.

### BACKGROUND OF THE INVENTION

Packages with a variety of structures and sizes are applied in various fields. The advent of serial-type packages applied to a serial packaging operating environment facilitates automated or semi-automated packaging. Examples of commonly seen serial packages are reel packages, tape packages, and serial packages for medications etc. Since these serial-type packages enable consecutive automated or semi-automated packaging, they facilitate quantity counting and serial boxing for transportation, and reduce labor cost, regardless of the amount of packages.

Among the abovementioned types of serial packages, serial packages for medication are the most common. These serial packages usually contain medication to be self-administered periodically by patients. Each dose may contain the same or different medications.

Patients must follow a desired medication regimen after seeing the doctors in order to obtain the best treatment. For short-term (e.g. 3 days) regimen, it is perhaps easier for patients to administer medication periodically, but for long-term regimen, it is quite common for patients to fail to take medication at the desired time or even forget to take it completely, which is the main factor that affects the result of a medical treatment. According to a British medical survey, despite that ninety percent of patients claim they follow doctor's instruction, but doctors think only thirty percent of patients actually cooperate (e.g. take medication at the prescribed time, follow diet, and regular activities of daily livings etc.). In addition, according to the estimation of International Medication Conference, patients not compliance to medication regimen have cost approximately a hundred billion dollars in medical resources.

Sometimes, with a large number of doses, patients may be confused as to whether a desired medication has been taken or not, especially for elderly and patients with chronic diseases. Currently there are aiding devices that can periodically remind patients to take medication, such as timers and dispensing boxes. However, timers can only remind patients of when to take medication, but does not track whether a medication has actually been taken. As for the dispensing boxes, it is required to divide the pills in advance, but for large quantity or variety of medication, this dispensing process is time consuming and error prone.

U.S. Pat. No. 4,617,557, U.S. Pat. No. 5,412,372, U.S. Pat. No. 6,335,907, U.S. Pat. No. 6,380,858, U.S. Pat. Nos. 6,574,166 and No. 6,662,081 propose blister packages, some with built-in microprocessors and electrical circuits to provide reminder, order and/or record of administration. However, these designs with microprocessors and electrical circuits provided therein are costly and non-recyclable. Further, blister packages are more expensive than bag-type packages, since special equipment is necessary and not compatible with existing packaging equipment used by hospitals. Additionally, blister packages are not suitable for packaging multiple pills. These disadvantages hinder the wide application of these prior arts.

Therefore, there is a need to provide a solution to solve the above discussed shortcomings of the prior art.

### SUMMARY OF THE INVENTION

In the light of forgoing drawbacks, an objective of the present invention is to provide a disposable serial package and its monitoring system for monitoring usage of the serial package.

Another objective of the present invention is to provide a simple disposable serial package and its monitoring system.

Still another objective of the present invention is to provide a low-cost disposable serial package and its monitoring system.

Yet another objective of the present invention is to provide a disposable serial package and its monitoring system compatible with existing packaging equipment used in hospitals.

In accordance with the above and other objectives, the present invention proposes a disposable serial package, which includes a plurality of package units detachably attached in series; and a plurality of conductive structures provided on the same side of the package units and electrically connected with each other, each of the conductive structures including a plurality of leads, each of the leads having a front end and a tail end, wherein the tail end of a second lead being connected to a first lead on the same conductive structure and a third lead of any one of the conductive structures is connected to the front end of the second lead of a succeeding conductive structure. In one preferred embodiment, the second lead is connected between the front end and the tail end of the first lead.

In one embodiment, the leads can be printed leads, and its quantity can be larger than that of the package units. The front ends of the leads comprise contact points.

Additionally, the disposable serial package may further comprise a Radio Frequency Identification (RFID) module detachably and electrically connected to the front ends of the leads of an outermost one of the package units; or alternatively, a Bluetooth module detachably and electrically connected to the front ends of the leads of an outermost one of the package units.

The package units can be bags attached in a series containing prescribed medicines. The disposable serial package may further comprise a recording medium on a surface of each of the package units. The recording medium is electrically connected to the corresponding conductive structure for recording information about the package unit on which the recording medium is provided.

The present invention also proposes a monitoring system, which includes: the disposable serial package described above and a monitoring device. The monitoring device has a connecting interface for electrically connecting to the leads on the disposable serial package, allowing setting of the quantity of the package units to be monitored and determining instantaneous quantity of the package units based on conducting states of the leads.

The abovementioned connecting interface is an electrical receptacle for electrically connecting to the front ends of the leads. The connecting interface may be a reader corresponding to the Bluetooth module or the RFID module above. In one embodiment, the monitoring device may further comprise a processing unit, a display unit, an operating unit and a memory unit. In one embodiment, the monitoring device may also include a wireless transmission unit and an audio generating unit.

Compared to the prior arts, the disposable serial package and its monitoring system proposed by the present invention provides simple and cheap conductive leads arranged on package units in a novel way, which can be used in cooperation with a monitoring device with a connecting interface to allow setting of the number of package units to be monitored as well as determining of the instantaneous number of package units based on the conducting state of the conductive leads. Thus, the present invention allows monitoring of package usage. Moreover, the design of the package according to the preset invention requires only an additional manufacturing step of printing conductive structures on the package units, and it does not affect the conventional packaging process. Thus, the present invention is compatible with existing packaging equipment, thereby solving problems of the prior art.

### BRIEF DESCRIPTION OF THE DRAWINGS

The present invention can be more fully understood by reading the following detailed description of the preferred embodiments, with reference made to the accompanying drawings, wherein:

FIG. 1 is a schematic diagram illustrating a first embodiment of a disposable serial package according to the present invention;

FIG. 2 is a schematic diagram illustrating the disposable serial package according to the present invention in use;

FIG. 3 is a schematic diagram illustrating an embodiment of a disposable serial package monitoring system according to the present invention;

FIG. 4 is a block diagram of a monitoring device according to the present invention;

FIG. 5 is a schematic diagram illustrating a second embodiment of the disposable serial package according to the present invention; and

FIG. 6 is a schematic diagram illustrating a third embodiment of the disposable serial package according to the present invention.

### DETAILED DESCRIPTION OF THE EMBODIMENTS

The present invention is described by the following specific embodiments. Those with ordinary skills in the arts can readily understand the other advantages and functions of the present invention after reading the disclosure of this specification. The present invention can also be implemented with different embodiments. Various details described in this specification can be modified based on different viewpoints and applications without departing from the scope of the present invention.

It should be noted that the drawings are schematic diagrams illustrating basic structures of the present invention. Thus, only those components related to the present invention are shown and described herein. The size, quantity, shapes etc. of these components may not be drawn to scale of actual implementations, which are simply a design choice. The layout of these components may be more complicated.

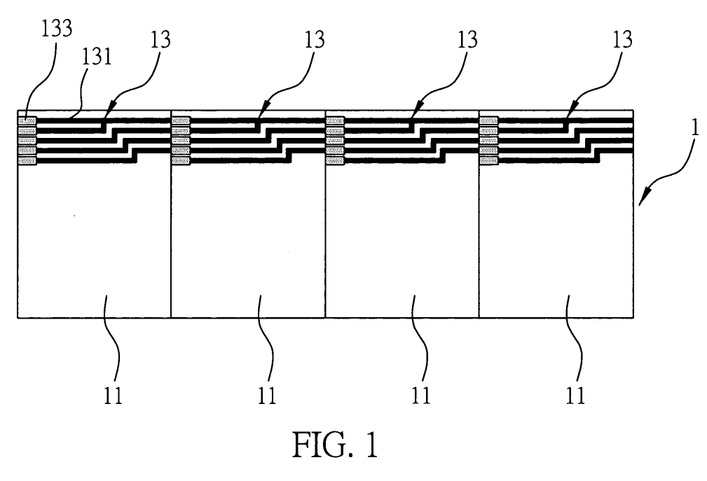

Referring to FIG. 1, shown is an embodiment of the disposable serial package according to the present invention. As shown, the disposable serial package 1 includes a plurality of package units 11 and a conductive structure 13 on the surface of each of the package unit 11. The package units 11 are in a series and can be tore away. In this embodiment, four serial medical packages are used to illustrate the package units 11. However, it should be noted that the present invention is not limited to this, but different quantities or types of package units 11 can be implemented.

Each conductive structure 13 is electrically connected in series according to the package units 11. The conductive structure 13 includes a plurality of leads 131 with front ends and tail ends, wherein the leads are arranged in parallel with equal spacing between each other. The tail end of the second leads 131 in each conductive structure 13 is connected between the front and tail ends of the first lead 131 to form a loop in the conductive structures 13. Looking at any one of the conductive structures 13 of the package units 11, the total number of front ends is one more than that of the tail ends of the leads 131.

In this embodiment, the conductive structure 13 comprises five leads as an example, that is, from the front end of the conductive structure 13, there are five leads 131; from the tail end of the conductive structure 13, there are only four leads. Each of the conductive structure 13 provided on the surface of package units 11 are identical, so the first lead 131 of a prior package unit 11 is connected to the first lead 131 of a succeeding package unit 11; the tail end of the third lead 131 of the prior package unit 11 is connected to the front end of the second lead 131 of the succeeding package unit 11; the tail end of the fourth lead 131 of the prior package unit 11 is connected to the front end of the third lead 131 of the succeeding package unit 11; the tail end of the fifth lead 131 of the prior package unit 11 is connected to the front end of the fourth lead 131 of the succeeding package unit 11 and so forth. The present invention is not limited to the particular number of leads described in this embodiment, but can be any suitable number.

The front ends of leads 131 comprise contact points 131 for providing signal transmission with external device via contacting. The plurality of leads 131 and the contact points 133 can be printed circuits serially printed on the surface of the package units 11 of the serial medical packages via a suitable circuit printing technique,. The front and tail ends of the neighboring conductive structures are continuously connected in such a way described above. The leads can be designed with a suitable width and thickness so that they are severed at the joint between two neighboring package units 11 when they are tore apart.

By the above design of the disposable serial package 1, the number of package units 11 at any moment can be easily determined by considering the state (short/open) of the loops of leads 131. For example, if an external device is electrically connected to the contact points 133 of each lead 131 on the leftmost package unit 1, then it can be determined that the first lead 131 thereof is connected to the loop of the fifth, fourth and third lead 131, respectively, which means that the first, second and third package units 11 counting from the right are not yet tore away. Thus, the present quantity of the package units 11 can be derived, i.e. the administration of medication can be determined. For a serial package, it may indicate whether the medication for breakfast, lunch or dinner is taken or not.

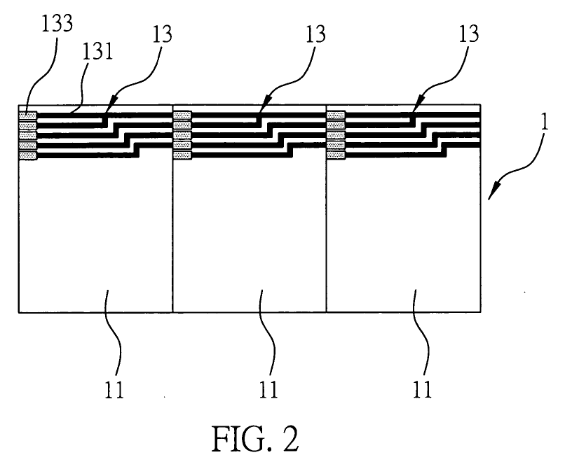

For example, if a user tears away an outermost package unit 11 from the serial package shown in FIG. 1, there will only be three package units 11 left, as shown in FIG. 2. The conductive path of the fifth lead 131 on the leftmost package unit 11 breaks at the tail end of the third lead 11 of the rightmost package unit 11 via the fourth lead 131 of the middle package unit 11, thus the fifth lead 131 forming an open circuit. Thus, by determining that the loop of the fifth lead 131 of the leftmost package unit 11 is open circuited, it can be derived that the originally rightmost fourth package unit 11 (as shown in FIG. 1) has been tore away. For a medical package, it may indicate that the dose for breakfast has already been taken. In another embodiment, if the disposable serial package 1 includes six consecutive package units 11, then seven leads 131 of each of the conductive structures 13 is required and so forth. In other words, the number of leads 131 on each of the conductive structures is one larger than the number of the package units 11.

Although this embodiment is illustrated using four package units 11 with 5 leads 131 on each of them, the actual number of package units 11 is not limited to this. The present invention may also be applied to other types of serial packages, such as the reel package. Additionally, the number of leads 13 may be provided according to the general amount of prescribed doses. For example, if in general, three days to one week of doses are usually prescribed by the doctors, then the number of leads 131 will be made accordingly. However, the maximum provision of leads is also possible with the redundant leads 131 being open circuit.

In addition, the present invention may provide recording medium on each package unit 11 electrically connected to the conductive structure to record the information related to the package unit 11, so as to facilitate identification of pills contained therein.

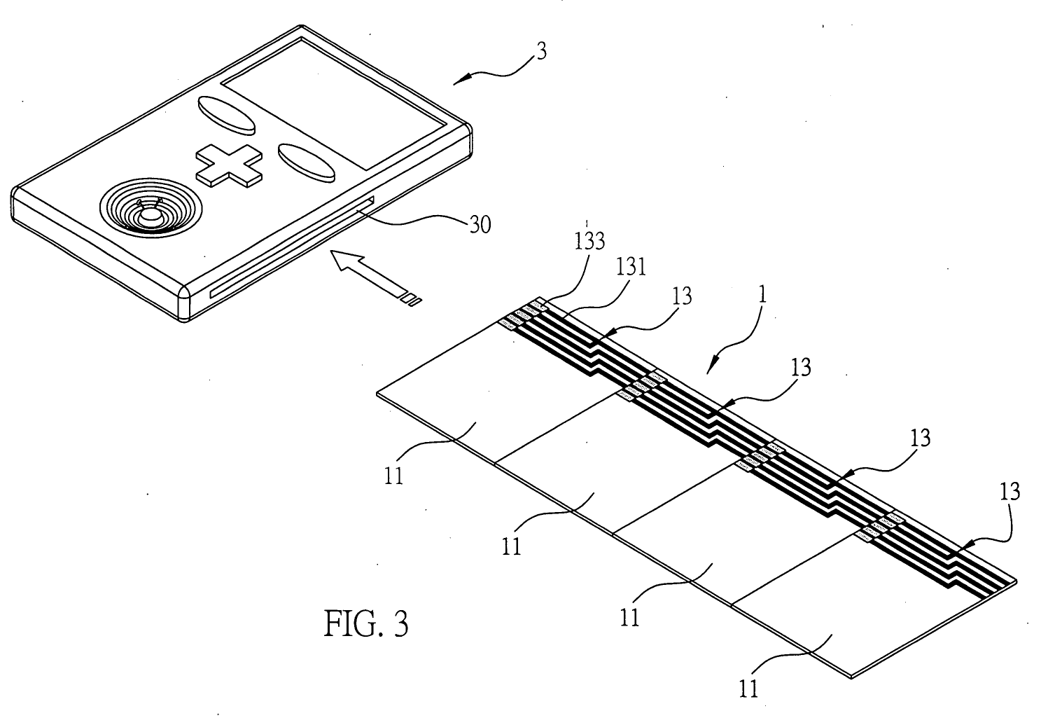

As shown in FIG. 3, in order to achieve monitoring and management of the abovementioned disposable serial package 1, the present invention further proposes a monitoring system that comprises the disposable serial package 1 and a monitoring device 3. The disposable serial package 1 is the same to that described above, so it will not be further illustrated. The monitoring device 3 comprises a connecting interface 30 that can be electrically connected to the plurality of leads 131 of the conductive structures 13. The monitoring device 3 allows a user to set the number of package units 11 and is able to determine the number of package units 11 based on the conducting state of the leads 131.

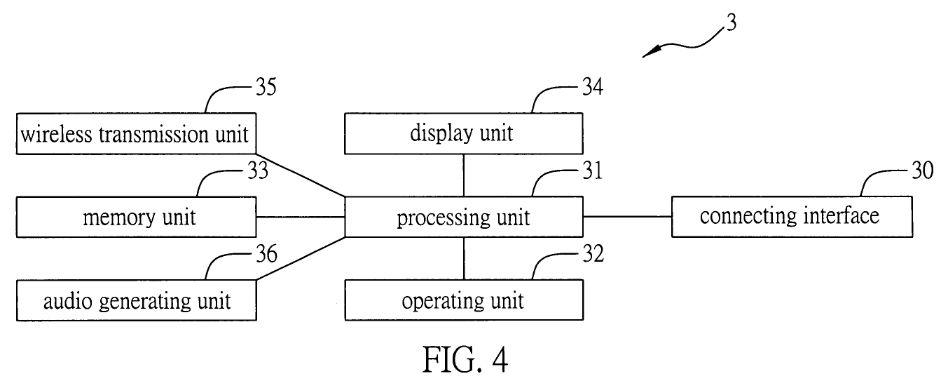

As shown in FIG. 4, the monitoring device 3 further comprises a processing unit 31, an operating unit 32, a memory unit 33 and a display unit 34. The operating unit 32 allows the number of package units 11 to be monitored and monitoring time etc. to be set. The memory unit 33 is used to record the related setting and detected results. The display unit 34 is used to display the status of the setting and/or the detected result. The processing unit 31 is used to perform the related setting, timing, detecting, recording, reading and data transmitting etc. based on control status. In this embodiment, the connecting interface 30 is a socket for electrically connecting to the contact points 133 of the leads 131. It is apparent to those with ordinary skill in the art that the connecting interface can be replaced with a wireless transmission, non-contact interface, such as a reader corresponding to a Bluetooth module or a radio frequency identification module.

Furthermore, the monitoring device 3 may further comprise a wireless transmission unit 35 and/or an audio generating unit 36. The audio generating unit 36 is for example a speaker that can send audio warning if a corresponding package unit 11 is not tore away at a preset time. The wireless transmission unit 35 is used to communicate with a predetermined server, so as to transmit monitoring messages to the doctor or the patient's relatives, for example, so as to monitor the patient's administration of medication in real time. The monitoring device 3 can be rented or lent to the patients along with the disposable serial packages 1, so the patients do not need to purchase one.

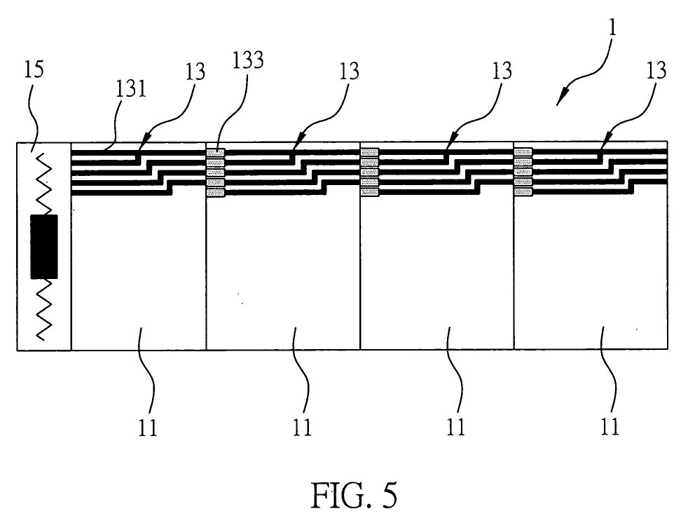

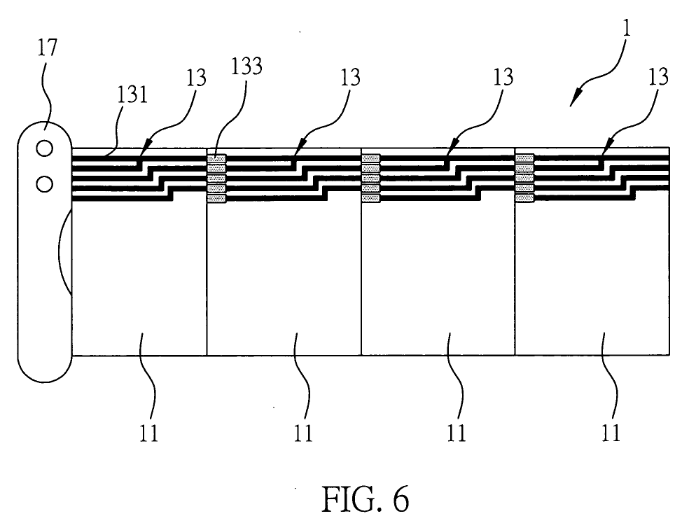

In accordance with the alternatives of the connecting interface 30 previously discussed, a non-contacting interface is also added to the disposable serial package 1. As shown in FIG. 5, the disposable serial package 1 can further comprise a radio frequency identification (RFID) module 15 that can be electrically and detachably connected to the front ends of the leads 131 of an outermost package unit 11. In FIG. 5, the RFID module 15 is shown to be attached to a side of the leftmost package unit 11 and electrically connected to the contact points (not shown) of the plurality of leads 131 thereof. The module is detachable and is thus recyclable. As shown in FIG. 6, the disposable serial package 1 may alternatively include a Bluetooth module 17 that can also be electrically and detachably connected to the front ends of the leads 131 of an outermost package unit 11 so as to communicate with an external device (e.g. monitoring device 3). In FIG. 6, it is attached to a side of the leftmost package unit 11 and electrically connected to the contact points (not shown) of the plurality of leads 131 thereof. The Bluetooth module 17 can also be recyclable. It should be noted that, by integrating wireless functionality into the disposable serial package 1, the monitoring device in the monitoring system can be replaced with a standard electronic device such as a personal computer. The user only needs to install a related program obtained from the hospital where he/she get her medication to be able to use it as a monitoring device of the present invention. Thus, the present invention is not limited to the particular form of monitoring device 3 described with respect to FIG. 3.

Therefore, the disposable serial package and a monitoring system proposed by the present invention provides simple and cheap conductive leads arranged on package units in a novel way, which can be used in cooperation with a monitoring device with a connecting interface to allow setting of the number of package units to be monitored as well as determining of the instantaneous number of package units based on the conducting state of the conductive leads. Thus, compared to the prior arts, the present invention allows monitoring of package usage. Moreover, the design of the package according to the preset invention requires only an additional manufacturing step of printing conductive structures on the package units, and it does not affect the packaging process. Thus, the present invention is compatible with existing packaging equipment.

The above embodiments are only used to illustrate the principles of the present invention, and they should not be construed as to limit the present invention in any way. The above embodiments can be modified by those with ordinary skills in the arts without departing from the scope of the present invention as defined in the following appended claims.

What is claimed is:

1. A disposable serial package, comprising:
a plurality of package units detachably attached in series; and
a plurality of conductive structures provided on the same side of the package units and electrically connected with each other, each of the conductive structures including a plurality of leads, each of the leads having a front end and a tail end, wherein the tail end of a second lead being connected to a first lead on the same conductive structure and a third lead of any one of the conductive structures is connected to the front end of the second lead of a succeeding conductive structure.

2. The disposable serial package of claim 1, wherein the second lead is connected between the front end and the tail end of the first lead.

3. The disposable serial package of claim 1, wherein the number of the leads is larger than the number of the package units.

4. The disposable serial package of claim 1, wherein the front ends of the leads comprise contact points.

5. The disposable serial package of claim 1, wherein the leads are printed lines.

6. The disposable serial package of claim 1, wherein the plurality of package units are bags attached in a series containing medicines.

7. The disposable serial package of claim 1, further comprising a Radio Frequency Identification (RFID) module detachably and electrically connected to the front ends of the leads of an outermost one of the package units.

8. The disposable serial package of claim 1, further comprising a Bluetooth module detachably and electrically connected to the front ends of the leads of an outermost one of the package units.

9. The disposable serial package of claim 1, further comprising a recording medium on a surface of each of the package units, the recording medium being electrically connected to the corresponding conductive structure for recording information about the package unit on which the recording medium is provided.

10. A monitoring system, comprising:
the disposable serial package of claim 1; and
a monitoring device with a connecting interface for electrically connecting to the plurality of leads on the disposable serial package, allowing setting of the quantity of the package units to be monitored and determining instantaneous quantity of the package units based on conducting states of the leads.

11. The monitoring system of claim 10, wherein the connecting interface is an electrical receptacle for electrically connecting to the front ends of the leads.

12. The monitoring system of claim 10, wherein the monitoring device further comprising a processing unit, a display unit, an operating unit and a memory unit.

13. The monitoring system of claim 12, wherein the monitoring device further comprising a wireless transmission unit and an audio generating unit.

14. The monitoring system of claim 10, wherein the second lead is connected between the front end and the tail end of the first lead.

15. The monitoring system of claim 10, wherein the number of the leads is larger than the number of the package units.

16. The monitoring system of claim 10, wherein the front ends of the leads comprise contact points.

17. The monitoring system of claim 10, wherein the leads are printed lines.

18. The monitoring system of claim 10, wherein the plurality of package units are bags attached in a series containing medicines.

19. The monitoring system of claim 10, wherein the disposable serial package further comprising a Radio Frequency Identification (RFID) module detachably and electrically connected to the front ends of the leads of an outermost one of the package units.

20. The monitoring system of claim 10, wherein the disposable serial package further comprising a Bluetooth module detachably and electrically connected to the front ends of the leads of an outermost one of the package units.

21. The monitoring system of claim 10, wherein the disposable serial package further comprising a recording medium on a surface of each of the package units, the recording medium being electrically connected to the corresponding conductive structure for recording information about the package unit on which the recording medium is provided.
